(19) United States
(12) Patent Application Publication
(10) Pub. No.: US 2009/0056342 A1
(43) Pub. Date: Mar. 5, 2009

(54) Methods and Systems for Gas Turbine Part-Load Operating Conditions

(75) Inventor: Joseph Kirzhner, Simpsonville, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/849,383

(22) Filed: Sep. 4, 2007

(51) Int. Cl. F02C 3/04; F02C 1/00

(52) U.S. Cl. 60/772; 60/734; 60/804

(57) ABSTRACT

A method and system for operating at partial load a gas turbine system having a compressor, a combustor, and a turbine. The method and system may include the steps of lowering a flow of fuel to the combustor, extracting air from the compressor so as to lower a flow of air to the compressor, and returning the extracted air to the turbine or a component of the gas turbine system other than the combustor. Extracting air from the compressor raises a combustion temperature within the combustor. Raising the combustion temperature maintains a combustion exhaust below a predetermined level, maintains stable combustion, and extends turbine turndown values.

### TECHNICAL FIELD

The present application relates generally to gas turbines and more particularly relates to methods and systems to extend gas turbine turndown values during part load operations.

### BACKGROUND OF THE INVENTION

Gas turbines generally have high efficiency at peak and base load operations. This efficiency, however, generally decreases during part-load operations. Turbine operation and exhaust emissions compliance may become an issue at such lower loads. Specifically, reducing the load on the turbine or “turndown” generally may be accomplished by reducing the fuel flow to the combustor. This reduction in fuel flow, however, makes the air-fuel mixture leaner such that sustaining combustion becomes more problematic as combustion temperatures are reduced. Unstable combustion may lead to excessive gas emission levels as well as to mechanical instability. Such instability potentially may damage elements of the gas turbine system as a whole. A typical turndown value of about forty percent (40%) to about thirty percent (30%) of full load may be expected while maintaining emissions compliance.

There is a desire, therefore, for improved methods and systems for gas turbine part-load operating conditions. Preferably, the improved methods and systems can extend the turndown value of a gas turbine within emissions compliance while maintaining or improving overall system efficiency.

### SUMMARY OF THE INVENTION

The present application thus provides a method of operating at partial load a gas turbine system having a compressor, a combustor, and a turbine. The method may include the steps of lowering a flow of fuel to the combustor, extracting air from the compressor so as to lower a flow of air to the combustor, and returning the extracted air to the turbine or a component of the gas turbine system other than the combustor. Extracting air from the compressor raises a combustion temperature within the combustor. Raising the combustion temperature maintains a combustion exhaust below a predetermined level such as a predetermined emissions compliance level.

The present application further describes a gas turbine system. The gas turbine system may include a compressor with a compressor discharge, a combustor in communication with the compressor, and a turbine in communication with the combustor. A compressor discharge extraction may extend from the compressor discharge to the turbine such that air from the compressor discharge may be extracted and returned to the turbine during partial load operations.

The present application further describes a gas turbine system. The gas turbine system may include a compressor and a combustor in communication with the compressor. The compressor may include a compressor discharge valve such that air from the compressor may be extracted during partial load operations.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a gas turbine system as is described herein.

FIG. 2 is a schematic view of an alternative embodiment of a gas turbine system as is described herein.

### DETAILED DESCRIPTION

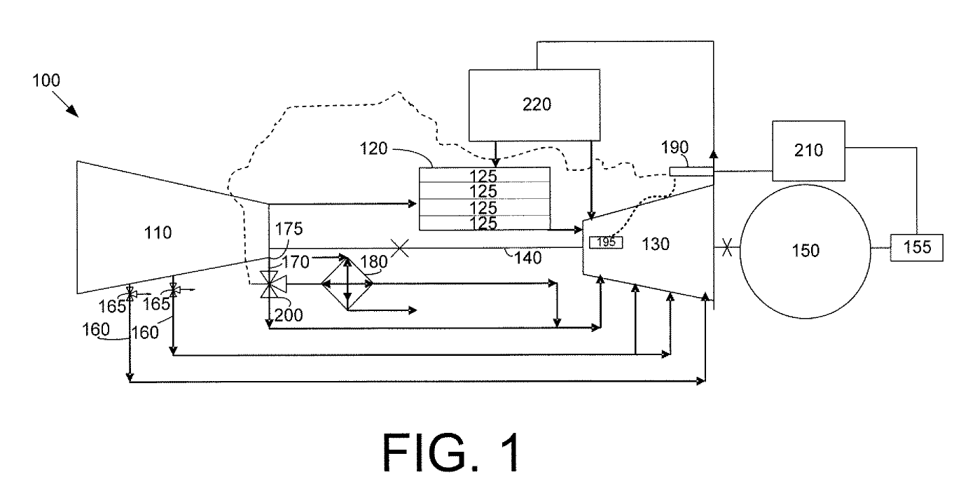

Referring now to the drawings, in which like numerals refer to like elements throughout the several views, FIG. 1 is a schematic view of an example of a gas turbine system 100. Generally described, the gas turbine system 100 may include a compressor 110, a combustor 120 with a number of cans 125, and a turbine 130. The gas turbine system 100 compresses ambient air in the compressor 110. The ambient air is then delivered to the combustor 120 where it is used to combust a flow of fuel to produce a hot combustion gas. The hot combustion gas is delivered to the turbine 130 where it is expanded to mechanical energy via a number of blades within a hot gas path. The turbine 130 and the compressor 120 generally are connected to a common shaft 140 that may be connected to an electric generator or other type of load 150. The load on the gas turbine system 100 may be determined by a load senor 155. The load sensor 155 may be of conventional design. The gas turbine system 100 may be a Dry Low-NOₓ (DLN) combustion system or any type of combustion system. The gas turbine system 100 may be part of combined cycle power plant or other types of generation equipment.

Emissions compliance levels may vary according to location, type of generating equipment, operating conditions, and other variables. For the purposes herein, emissions compliance means a predetermined limit on gas turbine emissions that should not be exceeded. Emissions compliance generally focuses on NOₓ and COₓ emissions and other types of byproducts.

One known method of staying within emissions compliance during part-load operations is to reduce the angle of the inlet guide vanes about the compressor 110 and to activate an inlet bleed heat flow while considering a Fuel Stroke Reference. Such a control system is shown in commonly owned U.S. Pat. No. 7,219,040 entitled “Method and System for Model Based Control of Heavy Duty Gas Turbine.”

In addition to the existing turbine designs, another emissions compliance method is to bleed off some of the compressed discharge air from the compressor 110 before it reaches the combustor 120. Specifically, the fuel flow to the combustor 120 may be reduced during turndown. The reduction in fuel flow makes the air/fuel mixture leaner and reduces the temperature within the combustor 120. Bleeding some of the compressor air also forces the temperature within the combustor 120 to increase so as to allow the gas turbine system 100 as a whole to operate at its intended fuel mixture.

In addition to raising the temperature in the combustor 120, this bleed air may be used to cool the parts of the turbine 130 within the hot gas path in a manner similar to existing compressor extractions. Specifically, in addition to existing extractions, the gas turbine system 100 also may have a number of cooling compressor stage extractions 160. For example, a stage 9 compressor extraction 160 may be used to cool turbine stages 2 and 3 while compressor extractions 160 from stages 13, 17, and 18, may be used to cool stages 1, 2 and 3 of the turbine 130. Other extraction locations and combinations may be used herein.

In this example, a compressor discharge extraction 170 from a compressor discharge 175 of the compressor 110 also may be used to cool an early stage of the turbine 130 in a manner similar to the compressor stage extractions 160 described above. The compressor stage extraction 170 may extend from the compressor discharge 175 to the first or second stage of the turbine 130. Other positions may be used herein.

Alternatively, the energy of the compressor discharge extraction 170 may be used for any desired operation with respect to the gas turbine system 100 or the power plant as a whole via a heat exchanger 180 or other type of heat transfer device. The heat exchanger 180 may be of conventional design. For example, the heat exchanger 180 may be in communication with the compressor discharge 175 and other elements of the combined cycle power plant as described above.

Operation of the extractions 160, 170 may be performed with the use of an exhaust temperature sensor 190. The exhaust temperature sensor 190 may be in communication with the exhaust flow from the turbine 130 so as to sense the output temperature therein. The exhaust temperature sensor 190 may be of conventional design. The exhaust temperature sensor 190 may be in communication with an extraction flow control valve 200. The extraction flow control valve 200 may be a conventional three-way valve that forwards the air of the compressor discharge extraction 170 either towards the turbine 130 for cooling therein or towards the heat exchanger 180 for use with the combined cycle power plant or otherwise. A further turbine temperature sensor 195 may be used with respect to the parts within the hot gas path of the turbine 130. Other sensors may be used herein.

A similar flow control valve 165 may be positioned about the compressor stage extractions 160 such that the compressor stage extractions also may be used to control the temperature of the combustor 120 or for other purposes. For example, the compressor extraction 160 may be used to cool the various stages of the turbine 130 as described above as well as for the stability of the combustor 120 during part-load operations. Specifically, the compressor stage extractions 160 may be used during part load operations to limit the air sent to the combustor 120 while cooling the turbine 130 or otherwise. The extraction flow control valve 165 may be a three-way valve as described above and may be in communication with the heat exchanger 180 or a similar type of device such that the heat and energy of the compressor stage extractions 160 also may be in communication with other elements of the combined cycle power plant as described above.

The amount, location, and temperature of the extractions 160, 170 may be determined by the temperature sensors 190, 195 in association with a controller 210. The controller 210 may be any type of programmable microprocessor. More than one controller 210 may be used. The controller 210 may store performance parameters, curves, equations, look up tables, other data structures as well as immediate feedback from the temperature sensors 190, 195, from the load sensor 155, and from other types of input. Specifically, the controller 210 may adjust selectively the location and volume of the source and the destination of the extractions 160, 170 based upon the exhaust temperature, the temperature of the parts in the hot gas path of the turbine 130, and/or the load on the gas turbine system 100 as a whole. The controller 210 also may completely shutdown certain cans 125 within the combustor 120. Shutting the combustor cans 125 down may further extend turndown values. The controller 210 may provide for shutdown of one or more of the cans 125 and vary the extractions 160, 170 so as to maintain a predetermined exhaust temperature and maintain the gas turbine system 100 within emissions compliance.

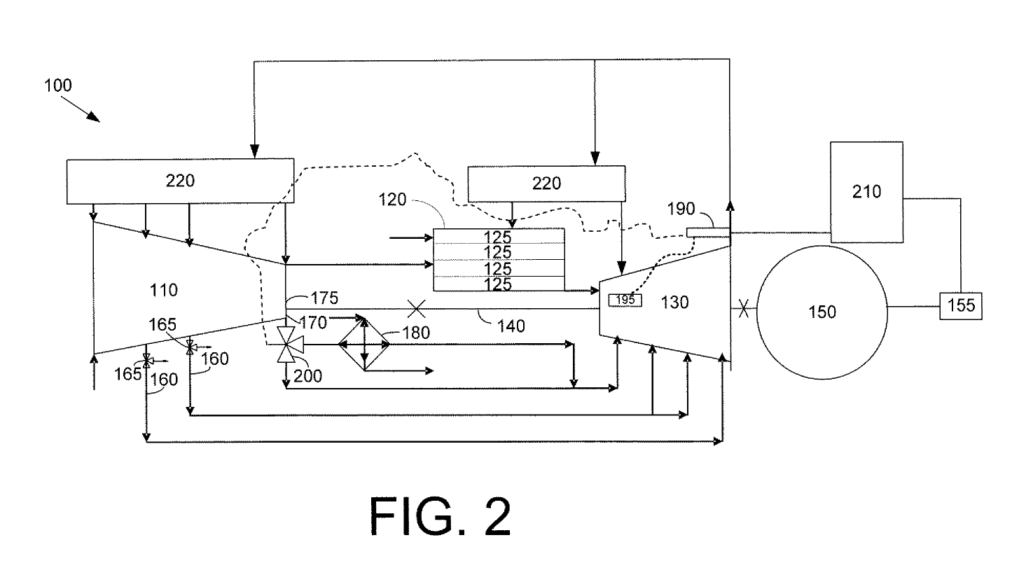

As is shown in FIG. 1, an exhaust gas recirculation 220 to the turbine 130 generally may be used to reduce certain emissions at full-load operations. FIG. 2 shows the use of an exhaust gas recirculation 220 for part-load operations. Specifically, the exhaust gas recirculation may be fed to the compressor 110 and/or the combustor 120. The exhaust gas recirculation 220 may be used to control the amount of oxygen in the air sent to the combustor 110 so as to increase the temperature of the combustor 120 by utilizing the heat and energy of the exhaust gas. Alternatively, the exhaust gas recirculation 220 may be delivered to the turbine 130 on a selective basis depending upon operations within the early stages of the turbine 130. The exhaust gas recirculation 220 may be delivered to the inlet, the discharge, or to any stage of the compressor 110 or the turbine 130 or to any combustor location. The exhaust gas recirculation 220 may be selectively delivered based upon operating conditions.

In use, the combination of these various techniques may reduce the turndown value of the gas turbine 100 as a whole to about 14.3% or less of full-load with a fuel consumption decrease of about nine percent (9%) or more. These turndown values may be achieved by maintaining the temperature of the combustor 120 above the minimum operating limits by controlling the amount of intake air. Air for part-load operations may be controlled by the selected extractions 160, 170 from the compressor discharge 175 and the compressor stages, by decreasing the number of compressor cans 125 in operation, and/or by returning exhaust gases selectively to the combustor 120, the compressor 110, and/or the turbine 130. Various combinations of these techniques also may be used. Likewise, the use of the compressor extractions 160, 170 reduces the temperature of the parts in the hot gas path of the turbine 130 so as to extend part life. The heat and energy of the extractions 160, 170 further may be delivered to the heat exchanger 180 so as to increase overall plant thermal efficiency or for other purposes.

It should be apparent that the forgoing relates only to the preferred embodiments of the present application and that numerous changes and modifications may be made herein by one of ordinary skill in the art without departing from the general spirit and scope of the invention as defined by the following claims and the equivalents thereof.

I claim:

1. A method of operating at partial load a gas turbine system having a compressors a combustor, and a turbine, comprising:
lowering a flow of fuel to the combustor;
extracting air from the compressor so as to lower a flow of air to the combustor; and
returning the extracted air to the turbine or a component of the gas turbine system other than the combustor.

2. The method of claim 1, wherein the step of extracting the air from the compressor comprises extracting the air from a discharge of the compressor.

3. The method of claim 1, wherein the step of extracting air from the compressor so as to lower a flow of air to the combustor comprises raising a combustion temperature within the combustor.

4. The method of claim 3, wherein the step of raising a combustion temperature within the combustor comprises maintaining a combustion exhaust of the combustor below a predetermined level.

5. The method of claim 1, wherein the step of returning the extracted air to the turbine comprises cooling the turbine.

6. The method of claim 1, wherein the step of returning the extracted air to a component of the gas turbine system other than the combustor comprises directing the extracted air to a heat exchanger.

7. The method of claim 1, wherein the step of extracting the air from the compressor comprises one or more compressor stages extractions and wherein the method further comprises directing the one or more compressor stage extractions to the turbine during the partial load operations.

8. The method of claim 1, wherein the volume of air extracted varies with a load on the gas turbine system.

9. The method of claim 1, wherein the volume of air extracted varies with an exhaust temperature from the turbine.

10. The method of claim 1, wherein the volume of air extracted varies with a temperature within the turbine.

11. The method of claim 1, wherein the combustor comprises a number of combustor cans and wherein the step of lowering a flow of fuel to the combustor comprises halting the flow of fuel to one or more of the number of combustor cans.

12. The method of claim 1, further comprising the step of recirculating an exhaust gas from the turbine to the compressor and/or the combustor so as to increase a combustion temperature within the combustor.

13. The method of claim 1, wherein the step of extracting air from the compressor comprises selectively varying a volume, an extraction location, and an extraction return.

14. A gas turbine system, comprising:
a compressor;
the compressor comprising a compressor discharge;
a combustor in communication with the compressor;
a turbine in communication with the combustor; and
a compressor discharge extraction extending from the compressor discharge to the turbine such that air from the compressor discharge can be extracted and returned to the turbine during partial load operations.

15. The gas turbine system of claim 14, further comprising a plurality of compressor stage extractions extending from the compressor to the turbine.

16. The gas turbine system of claim 14, wherein the compressor discharge extraction comprises a three-way valve thereon.

17. The gas turbine system of claim 16, further comprising a heat exchanger in communication with the compressor discharge extraction via the three-way valve.

18. The gas turbine system of claim 14, further comprising a load sensor to determine the load on the gas turbine system.

19. The gas turbine system of claim 14, further comprising one or more temperature sensors in communication with the turbine.

20. The gas turbine system of claim 14, further comprising an exhaust gas recirculation line extending from the turbine to the compressor and/or the combustor.

21. A gas turbine system, comprising:
a compressor;
a combustor in communication with the compressor; and
the compressor comprising a compressor discharge valve such that air from the compressor can be extracted during partial load operations.
